(19) United States
(12) Patent Application Publication
(10) Pub. No.: US 2016/0335300 A1
(43) Pub. Date: Nov. 17, 2016

(54) Searching Large Data Space for Statistically Significant Patterns

(71) Applicant: DataESP Private Ltd., Singapore (SG)

(72) Inventors: Yang WANG, Waterloo (CA); Ryan ANDERSON, Brunner (CA); Zhuang FAN, Kitchener (CA)

(73) Assignee: DataESP Private Ltd., Singapore (SG)

(21) Appl. No.: 14/856,362

(22) Filed: Sep. 16, 2015

(30) Foreign Application Priority Data
May 13, 2015 (SG) 10201503755Q

(51) Int. Cl. G06F 17/30

(52) U.S. Cl. CPC G06F 17/30327; G06F 17/30424

(57) ABSTRACT

According to embodiments of the present disclosure, a method and a distributed processing system are provided to discover statistically significant patterns from arbitrarily large data set by statistical analysis. The present disclosure provides new distributed system and algorithm of detecting statistical patterns of different orders. Also, the present disclosure provides effectively traversing data domain for pattern candidate generation that supports multi-agent distributed computation model. By increasing and decreasing the number of agents, the system is able to handle bigger or smaller problems. Further, the present disclosure provides a scheme of partitioning data in distributed storage more efficiently for statistical analysis.

### TECHNICAL FIELD

The present disclosure relates to a method of searching a large data space for statistically significant patterns, and more particularly to a method of searching a large data space for statistically significant patterns using a tree architecture, truncation algorithm, partitioning scheme and distributed processing system. The present disclosure can be applied but is not limited to processing big data, such as social media data, scientific research data, and industrial process data, on a distributed processing system.

### BACKGROUND

In the era of big data analysis, automatically uncovering the qualitative and quantitative statistically significant patterns becomes a basic task. With the ever growing size of available data, however, especially when the data is too large to reside on a single computer, discovering a complete set of inherent patterns and regularities turns out to be non-trivial, especially in a hypothesis generation stage when domain knowledge is not available, too weak, or not desired.

Consider an analysis domain described by N attributes (features or variables). For each of the N attributes, there is a domain of possible values. The goal of pattern discovery is to find the relations among the attributes and/or their values by their observed occurrences. If the relationships are statistical by nature, and we are trying to uncover statistically significant relationships, the pattern discovery process becomes a process to search within the domain characterized by the N attributes for statistically significant relationships using an observation set D containing M observations (samples or records).

In statistical pattern discovery, first of all, in a strict sense, higher order patterns cannot be induced from lower order patterns and vice versa. This implies that a pattern can only be a pattern if it passes a statistical significance test. From another viewpoint, it implies that the entire problem domain has to be explored. This phenomenon is less important when dealing with small problem domains where exhaustive search is feasible. When the problem domain becomes large, however, we will be facing several challenges.

Exhaustive domain search for candidates of different orders is no longer feasible due to the curse of dimensionality. Strategies for pruning the search space become necessary. Furthermore, with an extraordinarily large domain, a search space pruning strategy running on a single computing unit can again become computationally infeasible. Ideally, a distributed algorithm that allows a number of independent candidate generation agents working on sub domains simultaneously without interfering each other should be the solution. The number of working agents will increase for larger problems or decrease for smaller ones. In the aspect of statistical tests, the atomic operation on the data is counting occurrences. When data becomes huge, especially when it cannot reside in the main memory or even local physical storage of a single computing unit, the performance of occurrence counting suffers.

What is needed is an improved system and method for searching large data space for high order statistical patterns in distributed and scalable manner in order to provide a capability to analyze extremely large data sets with conventional computing equipment.

### SUMMARY

Embodiments of the present disclosure provide a self-organizing candidate tree algorithm for searching large data domain for pattern candidates of different orders that support distributed computing using multiple agents. With a sorted list of atomic events in a data domain, a qualified tree node grows to the next order (generation) by turning all its siblings at its right if any to its children.

Advantageously, by building a candidate list in a tree this way, it is guaranteed that no potential candidates are missing, at the same time, no duplicated candidates are to be tested. In addition, from any qualified node on, higher order candidates are generated solely with the information contained by the direct parent, which is the reason why it is named as a self-organizing tree. In a distributed computing environment, this is highly desired as a working unit does not need to communicate with other nodes.

Further, the embodiments of the present disclosure provide a candidate tree pruning strategy to eliminating non-informative candidates to avoid exhaustive search. This strategy is operational on local tree branches, which supports distributed computing. If a subspace of the domain is to be excluded from further exploration, we disqualify a node according to the pruning criteria, then no additional candidates in the subspace will be generated.

Embodiments of the present disclosure provide a data partition method that distributes data horizontally across distributed data stores for efficient occurrence counting by multiple agents. Any tabular data set is horizontally partitioned. Each of the partition has all the attributes, but just a portion of the observations, and will reside on one node of a distributed storage system such as the Hadoop distributed file system. This partition strategy guarantees that occurrence counts on each partition can be summed to obtain the total count of the occurrence in the complete data set, which makes the counting operation extremely efficient on distributed systems such as Hadoop MapReduce and Spark.

Embodiments of the present disclosure provide a distributed system design for discovering high order statistically significant patterns from a large data set. The system takes advantage of a multi-agent architecture, and is able to handle arbitrarily large data sets by adding new computing and storage nodes.

Embodiments of present disclosure, in view of generality, versatility, efficiency and flexibility, are well suited for automatic pattern discovery, hypothesis generation, predictive modelling and trend detection from arbitrarily large data sets. Applications are evident in big data analysis, data mining, social media analysis, health-care, manufacturing and other fields where data analysis is required.

According to a first aspect of the present disclosure, a method of searching large data space for statistically significant patterns is provided. The method comprises steps of collecting primary events of a plurality of attributes from a data set having a plurality of observations; initializing a tree architecture by setting a virtual root and setting the primary events of different attributes as nodes in a next level of the virtual root in a sorted order; growing the tree architecture to a next level by selecting one leaf node at a time among the nodes and turning sibling nodes at the right of the selected leaf node into its children, for each of the leaf nodes; generating compound events having at least two of the primary events with different attributes from the tree architecture by traversing from the virtual root to a leaf node; verifying whether each of the compound event meets a predetermined criteria; if the compound event fails to meet the predetermined criteria, disqualifying any further compound events containing the failed compound event from the tree architecture; if the compound event meets the predetermined criteria, it becomes a pattern candidate, then verifying the pattern candidate is a statistically significant pattern; and repeating the steps after the step of growing the tree architecture until level of the tree architecture reaches a pre-defined order limit or no new children can be generated.

According to a second aspect of the present disclosure, a distributed processing system for searching large data space for a statistically significant pattern is provided. The system comprises a plurality of storage nodes configured for storing data slices partitioned from a data set having a plurality of observations, collecting primary events having attributes from a data set having a plurality of observations and initializing a tree architecture by setting a virtual root and setting the primary events as leaf nodes in a next level of the virtual root in a sorted order; and a plurality of computing nodes configured for being allocated for a set of nodes of different attributes that belong to one parent and performing the following steps for the set of nodes; growing the tree architecture to a next level by selecting one leaf node at a time among the set of nodes and turning the sibling nodes of the selected leaf node at the right side to its children at a next level; generating compound events having at least two of the primary events with different attributes from the tree architecture; verifying whether each of the compound event meets a predetermined criteria; if the compound event fails to meet the predetermined criteria, disqualifying any further compound events containing the failed compound event from the tree architecture; if the compound event meets the predetermined criteria, it becomes a pattern candidate, the verifying the candidate is a statistically significant pattern; and repeating the steps after the step of growing the tree architecture until level of the tree architecture reaches a pre-defined order limit or no children can be generated.

According to a third aspect of the present disclosure, a computer readable medium containing program codes for searching large data space for a statistically significant pattern is provided. The program codes execute steps of: collecting primary events having attributes from a data set having a plurality of observations; initializing a tree architecture by setting a virtual root and setting the primary events of different attributes as leaf nodes in a next level of the virtual root in a sorted order; growing the tree architecture to a next level by selecting one leaf node at a time among the nodes and turning sibling nodes of the selected leaf node at the right side into its children at a next level; generating compound events having at least two of the primary events with different attributes from the tree architecture by traversing from the virtual root to a leaf node; verifying whether each of the compound event meets a predetermined criteria; if the compound event fails to meet the predetermined criteria, disqualifying any further compound events containing the failed compound event from the tree architecture; if the compound event meets the predetermined criteria, it becomes a pattern candidate, then verifying the candidate is a statistically significant pattern; and repeating the steps after the steps of growing the tree architecture until level of the tree architecture reaches a pre-defined order limit or no children can be generated.

Features and advantages of the invention will become more readily apparent from the following detailed description when considered in conjunction with the accompanying drawings. In this respect, before explaining at least one embodiment of the invention in detail, it is to be understood that the invention is not limited in its application to the details of construction and to the arrangements of the components set forth in the following description or the examples provided therein, or as illustrated in the drawings. The invention is capable of implementation in accordance with other embodiments, and of being practiced and carried out in various ways. Also, it is to be understood that the phraseology and terminology employed herein are for the purpose of description and aiding understanding, and should not be regarded as limiting.

### BRIEF DESCRIPTION OF THE DRAWINGS

FIGS. 1A to 1D illustrate a method of generating a tree architecture in an accordance with the present disclosure which can be used for generating compound events by extracting all the combinations of given primary events.

FIG. 2 is a flow chart illustrating a method of discovering statistical pattern using a self-organizing candidate tree and truncation scheme.

FIG. 3 illustrates a horizontal partitioning scheme according to an embodiments of the present disclosure.

FIG. 4 shows a network diagram illustrating a distributed processing scheme according to an embodiment of the present disclosure.

FIG. 5 is a flow chart illustrating a method of discovering statistical pattern using distributed processing system.

### DETAILED DESCRIPTION

In the present disclosure, depiction of a given element or consideration or use of a particular element number in a particular FIG. or a reference thereto in corresponding descriptive material can encompass the same, an equivalent, or an analogous element or element number identified in another FIG. or descriptive material associated therewith. The use of “/” in a FIG. or associated text is understood to mean “and/or” unless otherwise indicated.

A pattern discovery process includes or contains two interconnected activities: the first is to generate pattern candidates, and the second is to determine if a candidate is a pattern candidate based upon their statistical significance. Candidate generation implements the strategy of problem domain searching, and pattern determination implements the statistical significance test. The present disclosure addresses both activities.

In accordance with an embodiment of the present disclosure, a method of discovering statistically significant patterns, or statistical patterns is described. The pattern discovery process in accordance with an embodiment of the present disclosure can be generally formulated as a two-step procedure, pattern candidate generation and candidate significance testing. Pattern candidate generation is directed to finding all the combinations of primary events, or compound events up to a specified order, and the candidate significance testing is to verify that pattern candidates meet predetermined criteria (Tc as will be described later), and worth further examination for statistically significant patterns.

As a starting point of the present disclosure, a few basic concepts are introduced. In accordance with the present disclosure, a large data set is provided containing a large number of observations in or upon which pattern discovery will conducted. Representative non-limiting examples of the large data set includes a record of transactions at a bookstore for the past 10 years; the Visa credit card transactions in Canada for the last ten years; or the text messages sent by mobile phone users of China in or since 2014.

A data set may be formed from a data source by text mining and/or extracting meaningful data from the data source. The data source may be generated by machine and/or human actions. The data set may be a large data set which cannot be treated, or is extremely inefficient to treat, using conventional data analysis techniques.

The data set may comprise M observations or samples. Every observation, or sample of data set may be described by N attributes, features or variables, each of which can take on a value from a finite set. Let X={X₁, . . . , X_{N}} represent this attribute set. The finite set from which any attribute, Xᵢ, can take a value may be defined as a domain of the attribute, and denoted by Dᵢ. The N attributes thus form an N dimensional space, D, which is the entire data space within which a set of observations are made, and from which patterns are to be discovered.

For example, suppose that the data set is a set of observations of transactions at a certain bookstore for the past ten years. The observations may include or be height, hair color, gender, and age of the people who bought books at the bookstore.

The attributes for observations may have corresponding names and values. For an observation, height may have values such as 170 cm, 175 cm, and 180 cm, or their ranges such as 160˜165 cm, 165˜170 cm, and 170˜175 m. The attribute set or a domain of the attribute, height Di may be represented as Di={170 cm, 175 cm, 180 cm, . . . } or Di={160˜165 cm, 165˜170 cm, 170˜175 m, . . . }.

Solely for the purpose of aiding understanding in the present description, this example considers only a few attributes, but in practical implementations for large data, a huge number of observations and its attributes will be taken into account.

In accordance with the present disclosure, a primary event or atomic event of an attribute Xi is a realization of Xi taking on a value from Di. That is, Xᵢ=xᵢ₁ is a primary event, where xᵢ₁ ΣDᵢ. For example, height=170 cm or height=160˜165 cm is a primary event or realization of this attribute.

Primary events may be collected, given, derived, or extracted from a data set or a data source. Any attribute-value pair found in the data set or data source can be a primary event. To collect primary events from a data set or data source, any publicly known algorithm for data collection may be used. As described below, the primary events will be used as a starting point or basic unit to discover statistical patterns or statistically significant patterns in accordance with an embodiment of the present disclosure.

In accordance with an embodiment, a compound event may be defined as a set of two or more primary events of different attributes. The order of a compound event may be defined as the number of primary events within the compound event. For example, (x₁₁, x₂₁, x₃₁) is a third order compound event of attributes x₁, x₂ and x₃. That is, (height=170 cm, hair color=black, gender=male) is a third order compound event of attributes, height, hair color and gender.

In accordance with an embodiment of the present disclosure, a pattern candidate may be defined as a compound event that meets a number of predetermined criteria, Tc. In an embodiment of the present disclosure, the predetermined criteria may be that the expected occurrence (E_{occur}) or probability of occurrence of a compound event that has higher value than a given threshold. The expected occurrences, or probability of occurrences may be calculated based upon probabilities of primary event inclusion in the compound event from a data set.

In accordance with an embodiment of the present disclosure, the expected occurrences, E_{occur} of a compound event with i primary events {x₁₁, x₂₁, . . . , xᵢ₁} under an independent model may be defined as a product of number of observations of data set M and the probabilities of each of the primary events which constitute the compound event and may be calculated as follows:

E_{occur}=M·ΠᵢP(xᵢⱼ) (1)

For a compound event with three primary events {x₁₁, x₂₁, . . . , xᵢ₁},

E_{occur}=M·P(x₁₁)·P(x₂₁)·P(x₃₁). (2)

Here, P(xij) is the marginal probability of a primary event xij in a data set and may be directly calculated from the data set as follows:

$$P ( xij ) = \frac{\# of occurrence of xij in a data set D}{M} \qquad ( 3 )$$

In an embodiment of the present disclosure, a compound event (x₁₁, x₂₁, x₃₁) may become a pattern candidate if its expected occurrences under an independent model according to equation (1) is greater than a given threshold, for instance, 25. The procedure for determining a pattern candidate may be performed on the fly is to see if the compound event is worth testing for statistical significance. The threshold can be selected, determined, or varied depending on application, considering various factors such as computing environment and required accuracy of the applications.

For the pattern candidate which meets a criteria of expected occurrence or a valid pattern candidate, a test may be applied to see if it is a statistically significant pattern. Only a pattern candidate which passed this test may be classified as a statistically significant pattern. In an embodiment, a statistically significant pattern, or a statistical pattern may be defined as a pattern candidate that passes a statistical significance test, Tp.

In an embodiment of the present disclosure, the statistical significance test, Tp may be a significant hypothesis test using an adjusted residual as described in “A. K. C Wong and Y Wang. High order pattern discovery from discrete-valued data. IEEE Tans. On Knowledge and Data Engineering, 9(6):877-893, 1997”. Residual is the difference between the actual occurrence and the expected occurrence. If the adjusted residual of the compound event (x₁₁, x₂₁, x₃₁) is greater than 1.96, the compound event may be classified as a statistically significant pattern with a confidence level of 95%. In a number of embodiments of the present disclosure, the statistical significance test Tp can be any form of statistical significance test to discover or extract meaningful statistical patterns from a database.

For example, suppose that we are given a data set of the Visa credit card transactions in Canada for the last ten years. Suppose further that we have in total 1000 transactions in the data set, and the primary events x₁₁: the Visa credit card was used for an electronics purchase and x₂₁: the Visa credit card was used by a female. The marginal probability of x₁₁ and x₂₁ are P(x₁₁)=0.2 and P(x₂₁)=0.5, respectively. The expected number of transactions of a female purchasing electronics can be calculated as 1000*0.2*0.5=100, provided that electronic purchase and gender of cardholders are independent. Since 100 is higher than a threshold, for instance, 25, the Tp test may be applied.

However, suppose that we observed from the actual number of transactions in the 1000 cases that only 10 transactions were electronic purchases made by female card holders. Then the residual is (10−100)=−90. Now we want to find out if −90 is statistically significant. So we calculate the adjusted residual by dividing −90 with the variance which is SQRT(1000*0.2*0.5*(1−0.2)*(1−0.5)). The result is −14.23. Assuming an asymptotic normal distribution of adjusted residual, at 95% confidence level, −14.23<−1.96, making it negatively significant. This implies that female card holders are not likely to use Visa to purchase electronics.

In a number of embodiments, the statistical significance test Tp may include or be any type of known significance test(s). For example, in addition to the adjusted residual, a simple thresholding and/or two-tail t-test may be used.

In a large data space, there are many attributes, the domain of which can also be quite large. The total number of combinations can be exponentially large with growing order. Even in a distributed computing environment, ideally an individual working node should minimize the communication with other nodes while working on its own sub domain. In light of these considerations, the present disclosure proposes a tree architecture which is dynamically generated on the fly from lower orders to higher orders.

The generation of tree architecture may be localized at one specific part of a data set, enabling a distributed working node to work on that part of data set by itself independently, without the need to communicate with other working nodes.

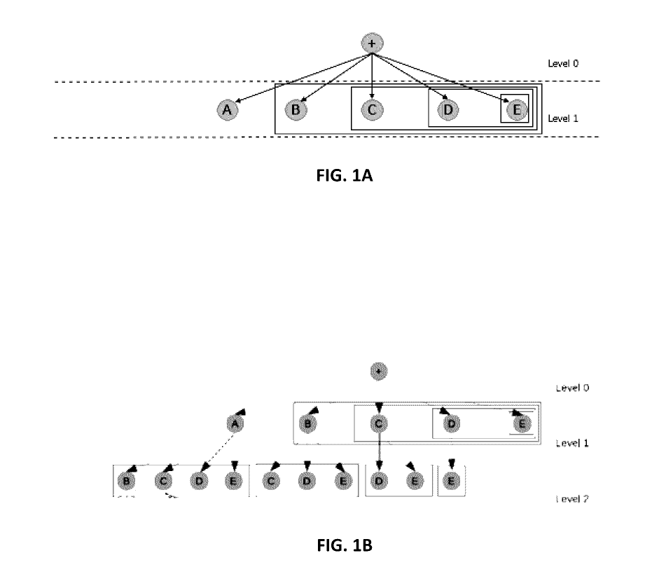

FIGS. 1A to 1D illustrate a method of generating a tree architecture, so-called a self-organizing tree, which can be used for generating compound events by extracting all combinations of given primary events in an accordance with an embodiment of the present disclosure. Also, a truncation or pruning scheme in an accordance with the present disclosure will be introduced to reduce the volume of processing data. For simplicity purposes, only five primary events A, B, C, D and E are considered. However, in the implementation with actual large data, there will be many more primary events depending upon application. Also, it is supposed that those primary events have different attributes and belong to the same data set.

In an embodiment, the data set may be partitioned into a plurality of slices. In that case, the processes described in association with FIG. 1A to 1D may be performed for a specific data slice or partitioned data set.

Referring to FIG. 1A, for purposes of the present description, the virtual root of the self-organizing tree may be set to be in virtual level 0. All the primary events, A, B, C, D and E may be collected from a given data set and may be sorted by a predetermined order, for example, from left to right and may be arranged in the next virtual level 1. The predetermined order may be an alphabetical order of names of the primary events.

For the purpose of the present description, in the self-organizing candidate tree, the primary event or node in the upper level or the previous level may be called a parent to the primary events or nodes in the lower level or the next level. Likewise, the node or primary event in the lower level or the next level may be called children to the node or primary event in the upper level or the previous level.

The self-organizing candidate tree is first created as an empty tree with a special node called root. The root node provides the entry to the tree and nothing else.

Level one or the immediate children of the root contains all possible primary events in a consistent sequence. Suppose that five primary events are collected as follows:
height=171-175 cm;
hair color=black;
gender=male;
age=15-24;
occupation=student.

The level one tree nodes can be organized by the attribute names and values alphabetically, or A: age=15-24, B: gender=male, C: hair color=black, D: height=171-175 cm, E=occupation=student

The self-organizing candidate tree may grow to the next level by iteratively selecting a leaf node in the current level and turning all the nodes with the same parent (its siblings) and at the right of the selected leaf node (or all the primary events in the right side as showed in FIG. 1A) to the next level as its children. This can be iteratively performed for each of the leaf nodes at the current level until no nodes can be moved to the next level.

Referring to FIG. 1B, the virtual level 2 of the self-organizing tree is generated. The children of the primary event A may be generated by turning all the primary events at its right, i.e. B, C, D and E to the next level 2. In the same manner, the children of the primary event B may be generated by turning all the primary events at its right, i.e. C, D and E to level 2. The children of the primary events C may be generated by turning D and E to level 2. The children of the primary events D may be generated by turning E to level 2. The last primary event, E will have no next level or children, since it has nothing in the right side.

Once more than two levels of primary events are generated, compound events or combinations of primary events with different attributes may be generated. As described above, compound events are a set of two or more primary events with different attributes. The compound events may be generated by reading primary events in paths from the virtual root to the leaf, or the primary event in the last level or the lowest level, one by one, or by traversing from the virtual root to each of the leaf nodes. In the present disclosure, the “leaf node” may be a node (or a primary event) with no children in the lower level in a tree architecture. Referring to FIG. 1B, compound events may be generated or extracted as {A,B}, {A,C}, {A,D}, {A,E}, {B,C}, {B,D}, {B,E}, {C,D}, {C,E} and {D,E}.

In an accordance with an embodiment of the present disclosure, the compound events may be generated or extracted from the self-organizing candidate tree, whenever a new level is generated. Each of the compound events is verified to become a valid pattern candidate. If a compound event fails to meet one or more criteria Tc, any further compound events containing that compound event are disqualified or removed from the self-organizing tree to reduce the volume of processing. For all the valid pattern candidates that meet the criteria, a test Tp to find out whether the candidate is a statistical pattern is performed. If a pattern candidate passes the test Tp, the candidate becomes a statistically significant pattern and is recorded as a statistical pattern.

In an embodiment, the Tc test and Tp test may be merged into one process. That is, for every compound event generated, both the Tc test and Tp test can be applied.

The process can be facilitated by disqualifying invalid compound events and their potential children while growing the tree architecture. This assumes that if a parent compound event cannot pass the pattern candidate test Tc, none of its children, that is, the compounds that contain the parent compound event, will not pass the pattern candidate test Tc. Hence, it is advantageous to skip the pattern candidate test Tc for the compound events containing such a parent.

The predetermined criteria Tc is designed to guarantee the following statistical significance test Tp is valid. Since a significant pattern exhibits the property that its observed occurrence is significantly greater or smaller than its expected occurrence, a statistical significance test usually examines the difference between the observed and the expected occurrence of a pattern candidate, that is, the residual.

In statistics, residual analysis based on asymptotic properties normally requires the expected occurrence of a compound event to be greater than a threshold for the test to be valid. As stated earlier, the expected occurrence of an ith order compound event under the independent assumption is calculated as M·ΠᵢP(xᵢⱼ) or equation (1). Since P(xᵢⱼ) as the marginal probability of the primary event xᵢⱼ, it is always less than or equal to 1. If the expected occurrence of this said compound event is less than a threshold for a valid statistical test, any of its children, that is, a higher order compound event containing the said compound event, will not be pattern candidates since all their expected occurrences will be less than the threshold. Hence, when a node of the self-organizing tree is deemed as a non-candidate, there is no need to further proceed with the process from that node and it should be pruned.

For the generated or extracted compound events, a verification is performed to find pattern candidates from the compound events. As described above, for each of the compound events, expected occurrence is calculated and checked to determine whether the expected occurrence is higher than a threshold.

Referring back to FIG. 1B, suppose that a compound event {A,D} failed to meet the criteria Tc. This is shown in FIG. 1B by a dotted line leading to non-candidate nodes. No more children are generated from the path containing the compound event {A,D} as shown in FIG. 1C.

Referring to FIG. 1C, the virtual level 3 is generated by selecting in turn a leaf node for all nodes at level 2, and turning all the sibling nodes at right of the selected leaf node into its children (at level 3) or primary events in the right side to the next level 2. The children are generated within a group of nodes having the same parent in level 1. For example, the children of primary event B in level 2 are generated by turning C, D and E to the level 3.

Compound events can be generated from the tree in FIG. 1C in the same manner as FIG. 1B. In FIG. 1C, compound events can be generated as {A,B,C}, {A,B,D}, {A,C,D},{A,C,E}, etc. . . . . Suppose that among the compound events generated from FIG. 1C, or level 3 of the self-organizing candidate tree, the compound events {A,C,D} and {A,C,E} failed to pass the Tc test as indicated in dotted line in FIG. 1C. Then, any future node containing {A,C,D} or {A,C,E} is disqualified and removed from the tree.

The final self-organizing tree may be generated as shown in FIG. 1D in consideration of a truncation or pruning scheme in accordance with an embodiment of the present disclosure. From the tree as shown in FIG. 1D, compound events can be generated as {A,B,C,E}, {A,B,D,E} at level 4 and {A,B,C,D,E} at level 5. For all these compound events, pattern candidate criteria Tc is the test, and for the valid pattern candidates, statistical pattern test Tp may be applied.

Similar to the above description, if the observed or actual occurrence of a candidate is zero, all of the higher order compound events from this will have zero occurrence. Hence, it should be pruned or truncated. Any domain knowledge that can be used to eliminate combinations of primary events can also be used to further prune the search space of pattern candidates.

For the purpose of the present description, the present disclosure described that the tree grows from top to bottom and by turning all the primary events in the right to the next level. However, a person having ordinary skill in the relevant art would understand the tree may grow in any direction, bottom to top, left to right, or right to left. Further, a person having ordinary skill in the relevant art would understand the turning the primary events in the right side to the children in the next level of the tree may be modified and implemented in various ways only if it is guaranteed that exhaustive combinations of the primary events or the compound events can be generated. For example, the children of each of the primary events may be generated by turning all the primary in the left to the next level.

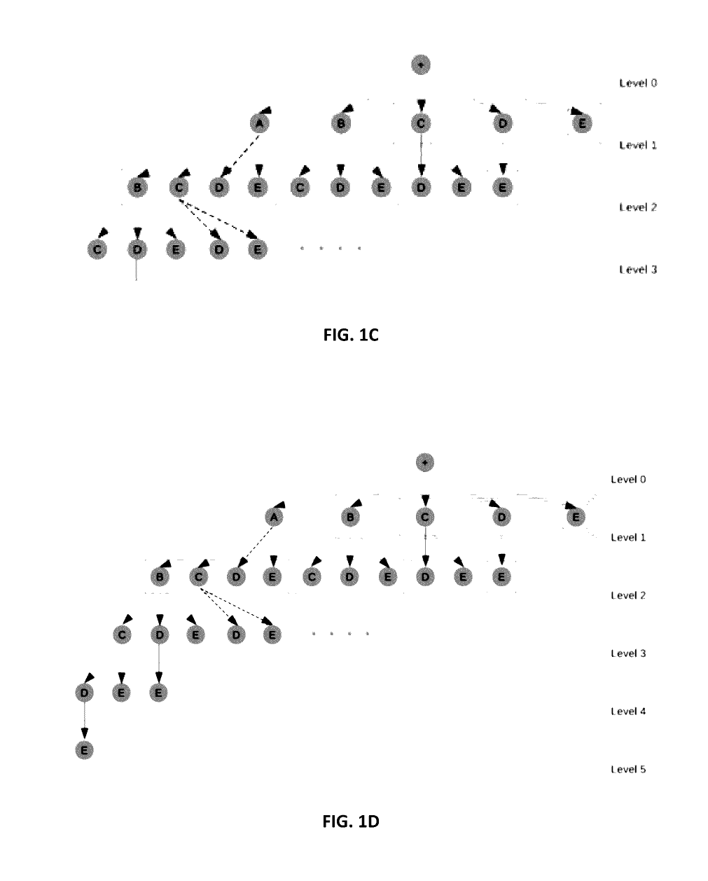

FIG. 2 is a flow chart illustrating a method of discovering statistical pattern using a self-organizing candidate tree and truncation scheme in accordance with an embodiment of the present disclosure.

In step S21, a self-organizing candidate tree is initialized by setting a virtual root and by setting level to zero.

In step S22, all the primary events are collected from a given data set or data source and placed as immediate children or nodes of the virtual root in level 1 in a sorted order, for example, from left to right. As described above, primary events may be any attribute-value pair found in the data set or data source. To collect primary events from a data set or data source, any publicly known algorithm(s) for data collection may be used.

In step S23, the tree grows to level 2 by selecting a leaf node, or a primary event among the primary events and turning all the sibling nodes at its right in level 1 to the next level.

In step S24, compound events are generated from the tree having at least two levels by reading primary events in paths from the virtual root to the leaf, or the primary event in the last level or the lowest level, one by one, or by traversing from the virtual root to each of the leaf in the tree.

In step S25, for every compound event, it is determined whether they meet a predetermined criteria Tc by calculating the expected occurrence (E_{occur}) or probability of occurrence of a compound event and comparing it with a given threshold (e.g., a predetermined or selectable/programmably specified threshold). If a compound event fails to meet the required criteria, or fails to become a pattern candidate, any further compound events containing that compound event are disqualified and removed from the self-organizing tree to reduce the volume of processing.

In step S26, for every valid pattern candidate, the statistical significance test Tp is applied to see if it is a statistically significant pattern. An adjusted residual test may be used as Tp, in a manner described above. If the pattern candidate is a statistically significant, it is recorded as statistical pattern. And if the occurrence of a pattern is zero, it should be removed from the self-organizing tree to reduce the volume of processing.

In step S27, if the level of the tree has not reached the pre-defined order limit, and there are more children to be generated, the next level 3 of the tree is generated for the primary events except for the primary events belonging to invalid patter candidates, in the same manner, by selecting a leaf node, and turning all the sibling nodes at its right to its children at the next level 3.

The process next moves back to step S23. Steps S23-S27 are repeated until the level has reached the pre-defined order limit, or the possible maximum which is level 5 in the example of FIG. 1A-1D, or no more children can be generated.

Self-organizing candidate tree with space truncation or pruning as above effectively deals with the exponential nature of dimensionality. In big data analysis, however, the huge number of records can also pose difficulties in conducting statistical pattern discovery, especially when the data set is too large to fit in one physical computing unit.

For statistical analysis dealing with data, the most basic operation is frequency counting, either with respect to finding the number of records of a single primary event xi or the number of records of a joint event (compound event) (xij). When the entire data set does not reside in one single storage unit, finding the frequency of a compound event can be difficult if parts of some records are spread across many storage units. For example, if we are counting the occurrence of a compound event (A, B, C), and part of A is stored in Unit 1, part of B in Unit 2 and part of C in Unit 3, the three units have to communicate with each other to find the number of records in which A, B and C occurred together.

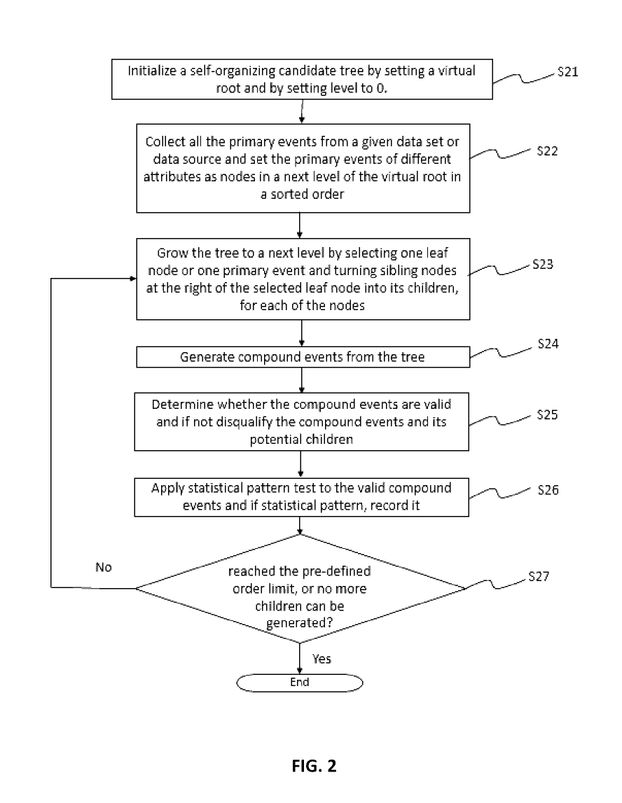

In light of this, in accordance with an embodiment of the present disclosure, a data partition strategy is proposed for efficiently processing large data. As shown in FIG. 3, if there are S storage nodes 20 available, the data set D may be partitioned into S subsets, each of which contains only M/S complete records. This partition strategy may be called horizontal partition because it will not break the integrity of any single record. A record or observation will reside in one of the S nodes and one of such nodes only. That is, all the primary events belonging to an observation will reside in the same node.

With horizontal partitioning, the counting of events, either primary or compound, can be conducted at each node 22, and their sums at the head node 21 is the total count. This simple operation does not require any communication or data exchange among the storage nodes, and hence significantly speeds up the process of counting.

Many approaches for distributing data and data operations have been studied, proposed and implemented. Among them, Hadoop with MapReduce and Apache Spark on Hadoop clusters are promising examples. The proposed horizontal partitioning of large data sets for frequency count according to the present disclosure can be easily implemented by using such approaches.

In accordance with embodiments of the present disclosure, we can utilize a distributed processing system for searching large data space for statistically significant patterns. Without the loss of generality, assuming there are S storage nodes and W computing nodes, the pattern discovery process according to the present disclosure can be processed using the S storage nodes and W computing nodes.

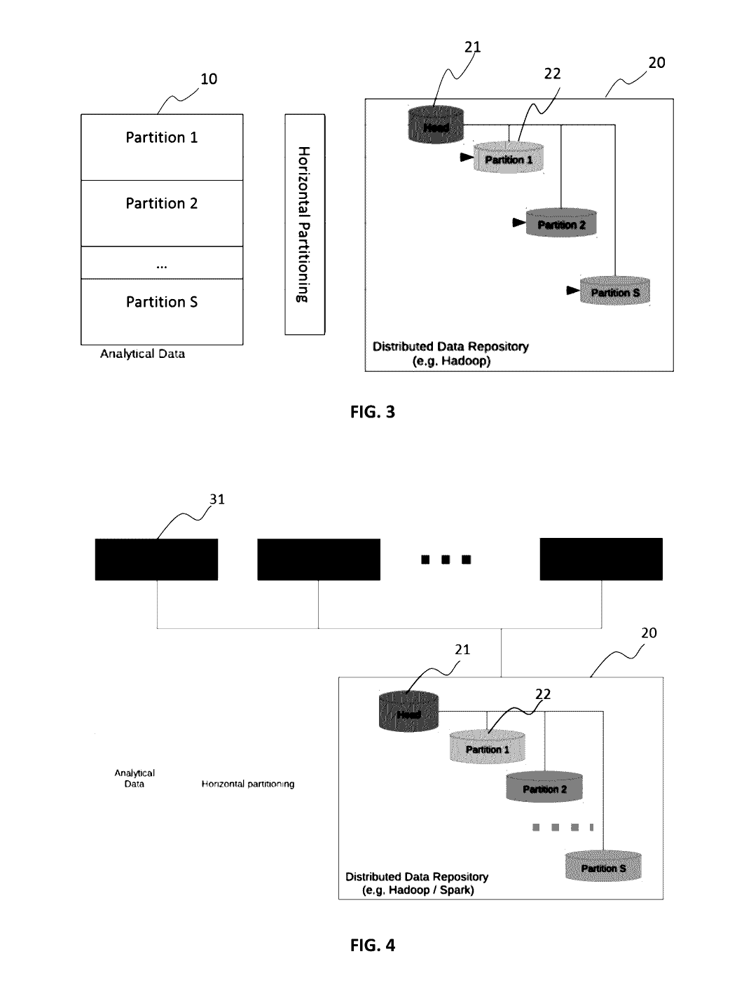

Referring to FIG. 4, each of the horizontally partitioned data (sub)sets may be stored in one of the storage nodes 22 of the storage cluster 20. On each of storage node 22, a self-organizing candidate tree may be generated as described in association with FIG. 1A-1D or FIG. 2. To generate the self-organizing candidate tree, the primary events may be distributed to one of the W computing nodes such that each computing node has all the children of one parent or in each computing node all the children belong to one parent. It is noted that at level 1 in the embodiment described in associated with FIGS. 1A-1D, only one computing node will be allocated since there is only one parent which is the virtual root. That is to say that at level 1, the primary events A, B, C, D and E described in associated with FIGS. 1A-1D have one parent or belong to one parent and may be allocated on one computing node. At level 2 on, however, more computing nodes can be utilized as necessary. For example, the branch starting with A at level 1 can be allocated to one computing node, and the branch starting with B at level 1 can be allocated to another computing node.

For each of the working node 31, the expected occurrence test Tc is applied to each path to the leaves, or the compound events to determine if they are of pattern candidates. The expected occurrence test Tc may be calculated using the storage cluster 20. If a pattern candidate found, test it with Tp. Tp may be calculated using the storage cluster 20. If it is a pattern, it is recorded as a statistically significant pattern in each of the storage node 20 and summed up by storage head 21.

If a compound event cannot be a pattern candidate, it is eliminated from the self-organizing candidate tree. The tree grows one level deeper by turning the remaining right siblings to children of the next level. If there are idling computing nodes, the leaves may be redistributed to the idling computing nodes. Processes end when the maximum level reached or no more children can be produced.

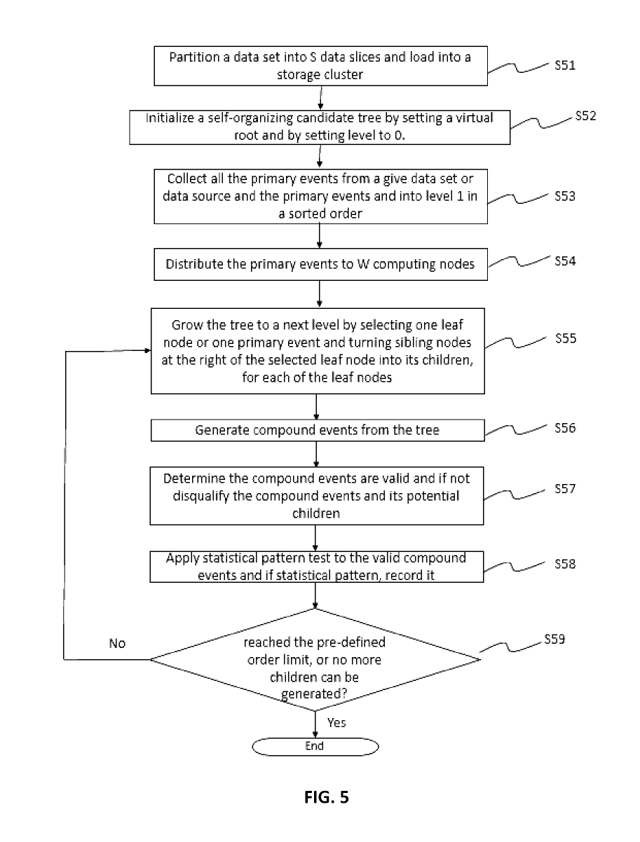

FIG. 5 is a flow chart illustrating a method of discovering statistical pattern using distributed processing system in accordance with an embodiment of the present disclosure.

In step S51, a data set is partitioned into S data slices and each of the data slice may be loaded into a storage cluster comprising S storage nodes. In step S52, a self-organizing candidate tree is initialized by setting a virtual root and by setting level to zero. In step S53, all the primary events are collected from the data set and placed as the immediate children of the virtual root in level 1 in a sorted order, for example, from left to right.

In step S54, the primary events are distributed to W computing nodes such that each computing node has all the children of a given parent. In step S55, in each of the computing nodes, the tree grows to the next level, stating at level 1 by selecting a leaf node and then turning all the sibling nodes at its right to its children. In step S56, in each of the computing nodes, compound events are generated from the tree having at least two levels by reading primary events in paths from the virtual root to the leaf or by traversing from the virtual root to each of leaf nodes in the tree, or the primary event in the last level or the lowest level, one by one in each of the computing nodes. In step S57, for every compound events, it is determined whether they meet a predetermined criteria, Tc by calculating the expected occurrence (E_{occur}) or probability of occurrence of a compound event and comparing it with a given threshold. In step S58, pattern candidates from step S57 are tested for significance by Tp. If a candidate passes the test, it becomes a pattern and is recorded.

In step S59, if the level of the tree has reached the pre-defined order limit or no new level can be generated, the process ends, otherwise, the process then moves back to step S55. Steps S55˜S59 are repeated until the level has reached the pre-defined order limit, or no new children can be produced (the level 5 in the example of FIG. 1A-1D).

A person having ordinary skill in the art will recognize that various types of memory and media readable by a computer such as described herein, e.g., a user computer, file management computer server, or other computers and machines may be used within the scope of embodiments of the present disclosure. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include or contain operating instructions stored therein/thereon, as well as instructions or instruction sets related to the system and particular method steps described above, and can operate on a computer by way of processing unit execution. It will be understood by those skilled in the art that such media can be at other locations instead of or in addition to a file management computer server to store program products, e.g., including software, thereon.

Aspects of particular embodiments of the present disclosure address at least one aspect, problem, limitation, and/or disadvantage associated with existing techniques for searching large data spaces for statistically significant patterns. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed systems, components, processes, or alternatives thereof, may be desirably combined into other different systems, components, processes, and/or applications. In addition, various modifications, alterations, and/or improvements may be made to various embodiments that are disclosed by a person of ordinary skill in the art within the scope of the present disclosure.

1. A method of searching large data space for statistically significant patterns, comprising steps of:
collecting primary events of a plurality of attributes from a data set having a plurality of observations;
initializing a tree architecture by setting a virtual root and setting the primary events of different attributes as nodes in a next level of the virtual root in a sorted order;
growing the tree architecture to a next level by selecting one leaf node at a time among the nodes and turning sibling nodes at the right of the selected leaf node into its children, for each of the leaf nodes;
generating compound events having at least two of the primary events with different attributes from the tree architecture by traversing from the virtual root to a leaf node;
verifying whether each of the compound event meets a predetermined criteria;
if the compound event fails to meet the predetermined criteria, disqualifying any further compound events containing the failed compound event from the tree architecture;
if the compound event meets the predetermined criteria, it becomes a pattern candidate, then verifying the pattern candidate is a statistically significant pattern; and
repeating the steps after the step of growing the tree architecture until level of the tree architecture reaches a pre-defined order limit or no new children can be generated.

2. The method of claim 1, wherein the primary event is any pair of attribute and its value found in the data set.

3. The method of claim 1, wherein the data set is a data slice partitioned from a large data set.

4. The method of claim 1, wherein the step of verifying whether the compound event meets a predetermined criteria further comprises steps of:
calculating expected occurrence of the compound event; and
determining whether or not the expected occurrence is higher than a predetermined threshold.

5. The method of claim 1, wherein the step of verifying the pattern candidate is a statistically significant pattern further comprises steps of:
calculating actual occurrence of the compound event in a data set;
calculating difference between the actual occurrence and the expected occurrence; and
determining whether or not the pattern candidate is a statistically significant pattern based upon the difference.

6. The method of claim 1, wherein the step of generating compound events of the primary events comprises step of:
generating combinations of the primary events by traversing from the virtual root to each of leaf nodes in the tree architecture.

7. The method of claim 1, wherein the data set is partitioned into a plurality of data slices and the data slices are stored in a distributed storage cluster.

8. The method of claim 1, wherein the steps after the steps of growing the tree architecture are performed by distributed computing nodes, and each of the distributed computing nodes performs the steps after the steps of the growing the tree architecture for a set of primary events that belong to one parent.

9. A distributed processing system for searching large data space for a statistically significant pattern, comprising:
a plurality of storage nodes configured for storing data slices partitioned from a data set having a plurality of observations, collecting primary events having attributes from a data set having a plurality of observations and initializing a tree architecture by setting a virtual root and setting the primary events as nodes in a next level of the virtual root in a sorted order; and
a plurality of computing nodes configured for being allocated for a set of nodes of different attributes that belong to one parent and performing the following steps for the set of nodes:
growing the tree architecture to a next level by selecting one leaf node at a time among the set of nodes and turning the sibling nodes of the selected leaf node at the right side to its children at a next level;
generating compound events having at least two of the primary events with different attributes from the tree architecture;
verifying whether each of the compound event meets a predetermined criteria;
if the compound event fails to meet the predetermined criteria, disqualifying any further compound events containing the failed compound event from the tree architecture;
if the compound event meets the predetermined criteria, it becomes a pattern candidate, the verifying the candidate is a statistically significant pattern; and
repeating the steps after the step of growing the tree architecture until level of the tree architecture reaches a pre-defined order limit or no children can be generated.

10. The system of claim 9, wherein the step of verifying whether the compound event meets a predetermined criteria further comprises steps of:
calculating expected occurrence of the compound event; and
determining whether the expected occurrence is higher than a predetermined threshold.

11. The system of claim 9, wherein the step of verifying the pattern candidate is a statistically significant pattern further comprises steps of:
calculating actual occurrence of the compound event in a data set;
calculating difference between the actual occurrence and the expected occurrence; and
determining whether the pattern candidate is a statistically significant pattern based upon the difference.

12. The system of claim 9, wherein the step of generating compound events of the primary events comprises step of:
generating combinations of the primary events by traversing from the virtual root to each of leaf nodes in the tree architecture.

13. A computer readable medium containing program code for searching large data space for a statistically significant pattern which executes steps of:
collecting primary events having attributes from a data set having a plurality of observations;
initializing a tree architecture by setting a virtual root and setting the primary events of different attributes as nodes in a next level of the virtual root in a sorted order;
growing the tree architecture to a next level by selecting one leaf node at a time among the nodes and turning sibling nodes of the selected leaf node at the right side into its children at a next level;
generating compound events having at least two of the primary events with different attributes from the tree architecture by traversing from the virtual root to a leaf node;
verifying whether each of the compound event meets a predetermined criteria;
if the compound event fails to meet the predetermined criteria, disqualifying any further compound events containing the failed compound event from the tree architecture;
if the compound event meets the predetermined criteria, it becomes a pattern candidate, then verifying the candidate is a statistically significant pattern; and
repeating the steps after the steps of growing the tree architecture until level of the tree architecture reaches a pre-defined order limit or no children can be generated.

14. The computer readable medium of claim 13, wherein the primary event is any pair of attribute and its value found in the data set.

15. The computer readable medium of claim 13, wherein the data set is a data slice partitioned from a large data set.

16. The computer readable medium of claim 13, wherein the step of verifying whether the compound event meets a predetermined criteria further comprises steps of:
calculating expected occurrence of the compound event; and
checking whether the expected occurrence is higher than a predetermined threshold.

17. The computer readable medium of claim 13, wherein the step of verifying the pattern candidate is a statistically significant pattern further comprises steps of:
calculating actual occurrence of the compound event in a data set;
calculating difference between the actual occurrence and the expected occurrence; and
determining whether the pattern candidate is a statistically significant pattern based upon the difference.

18. The computer readable medium of claim 13, wherein the step of generating compound events of the primary events comprises:
generating combinations of the primary events by traversing from the virtual root to each of leaf nodes in the tree architecture.

19. The computer readable medium of claim 13, wherein the data set is partitioned into a plurality of data slices and the data slices are stored in a distributed storage cluster.

20. The computer readable medium of claim 13, wherein the steps after the steps of growing the tree architecture are performed by distributed computing nodes, and each of the distributed computing nodes performs the steps after the steps of the growing the tree architecture for a set of primary events that belong to one parent.
